(19) United States
(12) Patent Application Publication
(10) Pub. No.: US 2009/0038413 A1
(43) Pub. Date: Feb. 12, 2009

(54) Force/moment sensor for measuring at least three orthogonal loads

(76) Inventors: Ulrich Seibold, Burnaby (CA); Robert Haslinger, Grobenzell (DE); Georg Passig, Munich (DE)

Correspondence Address: COLLARD & ROE, P.C., 1077 NORTHERN BOULEVARD, ROSLYN, NY, 11576, US

(21) Appl. No.: 12/221,489

(22) Filed: Aug. 4, 2008

(30) Foreign Application Priority Data
Aug. 7, 2007 (DE) 10 2007 037 262.2

(51) Int. Cl. G01D 7/00

(52) U.S. Cl. 73/862.043

(57) ABSTRACT

In a force/moment sensor for measuring at least three orthogonal loads, there are provided rod-shaped elements formed as glass fibers which have no support structure and are fixed in platforms. In one embodiment, the rod-shaped portions can form one continuous glass fiber or a small number of glass fibers, with the one or plurality of fibers being wound in an undulating configuration around a virtual cylinder. The glass fibers can be provided with a coating.

### CROSS REFERENCE TO RELATED APPLICATIONS

Applicants claim priority under 35 U.S.C. §119 of German Application No. 10 2007 037 262.2 filed August 7, 2007.

### BACKGROUND OF THE INVENTION

The present invention relates to a force/moment sensor for measuring at least three orthogonal loads, comprising two platforms and at least three identical rod-shaped elements arranged between the two platforms, each of said platforms having at least three support point elements formed thereon and each of said rod-shaped elements being provided with at least one member reacting on an applied force.

### DESCRIPTION OF PRIOR ART

With reference to FIGS. 1a to 1c, the basic arrangement of a special variant of a so-called Stewart platform will be described hereunder. The Stewart platform comprises two plane surfaces which are connected to each other by six rods. The lower support point elements in FIG. 1a, i.e. the support point elements Aᵢ², Bᵢ², Cᵢ2, with i=1, 2, are arranged on a plane E² and on a circle with a radius R=0²A₁² around the center 0². The upper support point elements in FIG. 1a, i.e. the support point elements Aᵢ^{l}, Bᵢ¹, Cᵢ¹, with i=1, 2, are arranged on a plane E¹ parallel to said plane E² at a distance h and on a circle with a radius r=0¹A₁¹ around the center 0¹. The axis passing through 0² and 0¹ stands vertically on the two planes. The points A₁ⁱ, A₂ⁱ, B₁ⁱ, B₂ⁱ, C₁ⁱ, C₂ⁱ are respectively connected by rods having an identical length l and identical mechanical properties.

If a virtual extension of said rods is imagined, respectively two of the rods will intersect each other at the points A, B and C. These points span a plane E which is parallel to the planes E¹ and E². The center of the circle passing through A, B and C is arranged on the axis passing through 0² and 0¹. The point 0 is defined to be the force application point. Adjacent support points have, on E², a constructionally required distance d² and, on E¹, a constructionally required distance d¹.

The mechanical properties of the Stewart platform are dependent on the values R, r, l, d² and d¹ and on the properties of the material. If the arrangement is used as a sensor, the forces and moments attacking at 0 will result in an elasto-mechanic deformation of the rods. The planes E, E¹ and E² are considered to have an ideal stiffness. Provided that, in addition thereto, all joints are ideal, i.e. are free of play and friction, and that forces will be transmitted only in the direction of the rods, it will be possible, with the aid of a coupling matrix C (6×6) and the stiffness k of the rods, to compute the loads applied at point 0 in the following manner from the length variation Δlᵢ of the rods:

$$( \begin{matrix}{F}_{x} \\ {F}_{y} \\ {F}_{z} \\ {M}_{x} \\ {M}_{y} \\ {M}_{z}\end{matrix} ) = C * ( \begin{matrix}k * Δ {l}_{1} \\ k * Δ {l}_{2} \\ k * Δ {l}_{3} \\ k * Δ {l}_{4} \\ k * Δ {l}_{5} \\ k * Δ {l}_{6}\end{matrix} )$$

With regard to the smaller length variations Δl₁ occurring in a sensor, the matrix C will remain approximately constant. As to its mechanical properties, the sensor is not isotropic. For instance, a force running in the z-direction will be supported by all rods, while there is also the possibility of load conditions where only one of the rods is subjected to the load.

However, depending on the selection of the amounts of R, r, l, d² and d¹, the sensor can be adapted to a given application within wide ranges.

In robotics, the Stewart platform is used as an actor by providing that the orientation of two plates relative to each other is adjustable by variation of the length of the rods. For use as a force/moment sensor (FMS), the above described basic arrangement is described e.g. in DE 41 01 732 C2. A basically similar arrangement is described in FR 25 29 333.

This known force/moment sensor comprises two plates oriented parallel to each other in the unloaded condition, two similar rods which have the same length in the unloaded condition and are arranged between the two plates, and joints respectively arranged on the rod ends and formed as joint heads by which the mutual coupling between the two plates is performed via support points provided on the plates.

In this arrangement, one of the plates has arranged thereon three pairs of support points distributed in uniform manner on a first circle which is concentric e.g. with the z-axis of a Cartesian coordinate system, and the other plate has arranged thereon again three pairs of support points distributed in uniform manner on a second circle which is concentric with the z-axis. Thereby, seen in a projection parallel to the z-axis, this arrangement results in six symmetrically distributed pairs of support points alternately arranged on the plates.

The known force/moment sensor is of a design comprising discrete measurement pick-up elements which are articulated to both plates with the aid of ball or pin joints. Force/moment sensors with six degrees of freedom, wherein the orthogonal three forces and three moments are measured by use of strain measurement strips, are commercially available only with diameters down to a minimum of 16 mm.

When, however, the constructional size of a force/moment sensor is to be miniaturized, the constructional design does not make it possible anymore to consider joints such as ball or pin joints to be free of play or friction. In case of sizes of this magnitude, manufacturing tolerances have an unfavorable effect. The bearing will either be susceptible to friction, causing the friction and the initial breakaway moment to be in the same order of magnitude as the forces to be measured, or they will have undesired play. In both cases, a conclusive measurement of forces will be impossible. Thus, along with a decreasing size of force/moment sensors, the precision required in manufacture and assembly will increase disproportionately. Consequently, the known ball and pin joints can be produced with the required precision only at the penalty of an unreasonably high expenditure with respect to working effort and costs.

A miniaturized, sterilizable force/moment sensor adapted to be accommodated also in instrument shafts designed for use in minimal-invasive surgery (MIC) and having inner diameters of about 4 to 15 mm, is described in DE 102 17 018 and is illustrated in FIG. 2.

The outer contour of this force/moment sensor has a circular cylindrical shape so as to allow for accommodation in a tube, e.g. in a shaft tube of an instrument for use in minimal-invasive surgery (MIC). Therefore, in FIG. 2, an upper platform 2 and a lower platform 3 are formed as circular cylindrical rings. For attachment in and on a first tube, platform 2 is provided with three bores 21, only two of them being visible in FIG. 2. For fixation in a second tube, also lower platform 3 is provided with corresponding bores 31.

The two circular cylindrical rings 2 and 3 are connected to each other by a total of six rods 4₁ to 4₆ via solid bearings 5₁³ to 5₆³ and 5₁² to 5₆² formed at the two ends of said rods. Thus, each of the rings has three pairs of support points uniformly distributed thereon, each of said pairs in turn elastically supporting two rod ends via said solid bearings.

By the solid bearings 5₂³ to 5₃³ provided in the—in FIG. 2—lower ends of the two rods 4₂ and 4₃, one of these three pairs of support points is formed. The rod axes of the two rods 4₁ and 4₂ extend in a V-shaped configuration from the—in FIG. 2—upper platform 2 to the lower platform 3; thereby, the rods 4₁ and 4₂ are supported, by means of the solid bearings 5₁³ to 5₂³ provided in their—in FIG. 2—lower ends, on the lower ring 3 in respectively different pairs of support points.

In FIG. 2, two of these pairs of support points can be seen on lower ring 3, said pairs of support points elastically supporting the rods 4₁ and 4₆ via the respective solid bearings 5₁³ to 5₆³ of these rods and, respectively, elastically supporting the rods 4₂ and 4₃ via the respective solid bearings 5₂³ to 5₃³ of the latter rods.

As illustrated in the perspective view of FIG. 2, a respective outwardly open, generally parallelepiped recess 6 is formed in all of the six rods 4—of which only rods 4₁ and 4₂ are visible in FIG. 2—so that the rods in their central portion have a U-shaped cross sectional area vertically to the longitudinal axis of the rod. The recess 6 formed in each rod 4 is closed by a bottom 6₃ towards the interior of the force/moment sensor 1.

In the above described arrangement of the rods 4, respective strain measurement strips—not illustrated in greater detail—can be provided outside on the longitudinal sides 6₁ and 6₂ of the rods. Further strain measurement strips can be provided both on the inner side and on the outer side of the bottoms 6₃ of the recesses 6.

As can be concluded from FIG. 2, it is also possible, instead of using the above strain measurement strips, to provide glass-fiber strain sensors 7, e.g. in the form of fiber Bragg sensors, centrally on the inner side of the bottom 6₃ of the recess 6 of each rod 4.

As evident from FIG. 2, such glass-fiber strain sensors 7 can be introduced via openings/recesses 32 in the outer surface of the cylindrical ring 3 and can be applied or bonded in the center of the bottom 6₃ of the recess 6 of the respective rods 4.

Although the monolithically configured sensor body known DE 102 17 018 is free of the disadvantages of the previously used force/moment sensors, such as e.g. difficulties encountered in miniaturization, play of the bearings and friction of the bearings, all of which will undergo a disproportionate increase along with miniaturization, and is as well free of assembly errors, this monolithically configured sensor body has a stiffness which, although it may be adaptable to the respective application, cannot be reduced below a lower limit due to material properties and manufacturing methods, with the result that this sensor body is not suited anymore to measure very small forces because the strains generated by the introduced forces are too small to still be reasonably measurable.

Further, research has shown that, e.g. in cardiac surgery, the forces applied in the suturing of tissue are far below one Newton. The measurement resolution of the sensor known from DE 102 17 018 does not make it possible anymore for the physician to assess the properties of the tissue. Further still, it has to be noted that the manufacture of such a sensor would be complex and expensive.

The above described problem in a monolithically configured sensor consists in the stiffness of the sensor body which should be produced from a material with good elastic properties. For this reason, plastics are not suitable for the purpose. Normally, special aluminum alloys and/or steel alloys are used which, however, have a high stiffness and with regard to the application discussed herein cannot be produced with any desired thinness.

### SUMMARY OF THE INVENTION

It is an object of the invention to provide a sterilizable force/moment sensor in a manner to enable it to measure also forces in the range of one Newton or distinctly under one Newton.

According to the invention, the above object is achieved, in a force/moment sensor for measuring at least three orthogonal loads comprising two platforms and at least three identical rod-shaped elements arranged between the two platforms, each of said platforms having at least three support point elements formed thereon and each of said rod-shaped elements being provided with at least one member reacting on an applied force. The rod-shaped elements are glass fibers which have no support structure and which are fixed in said platforms so that each respective glass fiber takes up only longitudinal forces when loads are acting in a random direction on one of said two platforms, whereas the other platform is fixed in position.

According to a first embodiment of the invention, rod-shaped elements, provided between platforms preferably oriented parallel to each other, are made of glass fibers without a support structure, which glass fibers are fixed in the platforms. Quartz glass, which the glass fibers are made of, has good elastic properties, and the glass fibers already have a thin shape right away. Thus, the manufacture of a force/moment sensor is restricted to the production of two platforms which serve for fixation of the glass fibers and for the introduction and the output of forces. Further, in the force/moment sensor of the invention, there is obviated the need for any sort of bonding of the measurement sites in or on the sensor body so that the assembly process is facilitated or, in dependence on the method used for manufacture of the platforms, any special fastening step may be wholly omitted. Further, no plastic deformation of the bonding sites will occur (hysteresis, creeping etc.)

According to a first embodiment of the invention, the force/moment sensor comprises at least three rod-shaped elements in the form of individual glass fibers which are each provided with at least one strain measurement site between the upper platform and the lower platform. The measuring method provided herein makes use of the fiber Bragg grating in the fibers, thus rendering it possible to measure forces and moments in all spatial directions. In uses where a higher stiffness is required, the same principle can be utilized by distributing additional fibers, with or without measurement sites, along the circumference of the platform.

According to an advantageous embodiment of the invention, the fibers can be provided with a coating of metal, ceramics or the like by use of suitable methods. Thereby, the stiffness can be set in a well-aimed manner; at the same time, the resolution will be enhanced.

According to a second embodiment of the invention, rod-shaped elements form a single glass fiber, said fiber being wound in an undulating configuration around a virtual cylinder. In this arrangement, the ends of the rod-shaped portions are fixed in the two platforms. At least two measurement sites have to be provided on the rod-shaped portions in order to perform measurements in three orthogonal spatial directions.

By the inventive provision of a single glass fiber, only one fiber is required for transmission of all measurement values. Thereby, the coupling of the force/moment sensor to the robotic structure is improved. The stiffness can be increased by a corresponding plural number of windings.

Further, the glass fiber as used herein can also be a double-refraction glass fiber. In this case, it will be possible to perform a simultaneous measurement of strain and temperature by each individual grating (at each measurement site). Such double-refraction fibers for simultaneous measurement of two values are known. (See e.g. http://www.bluerr.com/papers/BRR-2000 Sensors Expo Anaheim p. 203.pdf.)

The simultaneous measurement of two values is of considerable interest in surgery because, when using electrosurgical devices, a local occurrence of high temperature gradients is possible. The ability to perform a simultaneous temperature measurement at all measurement sites is thus of high interest. In view of the desired miniaturization of the force/moment sensor, the conventional temperature measurement in force/moment sensors, performed by applying a strain measurement strip at an unloaded structural site, would be possible only in a restrictive way because the available space is limited and really unloaded sites can be obtained only by use of a massive volume of material.

### BRIEF DESCRIPTION OF THE DRAWINGS

The present invention will be described in greater detail hereunder with reference to the accompanying drawings. In the drawings—

FIGS. 1a to 1c are schematic diagrams of a Stewart platform, notably seen in lateral view in FIG. 1a, in plan view in FIG. 1b, and in perspective view in FIG. 1c;

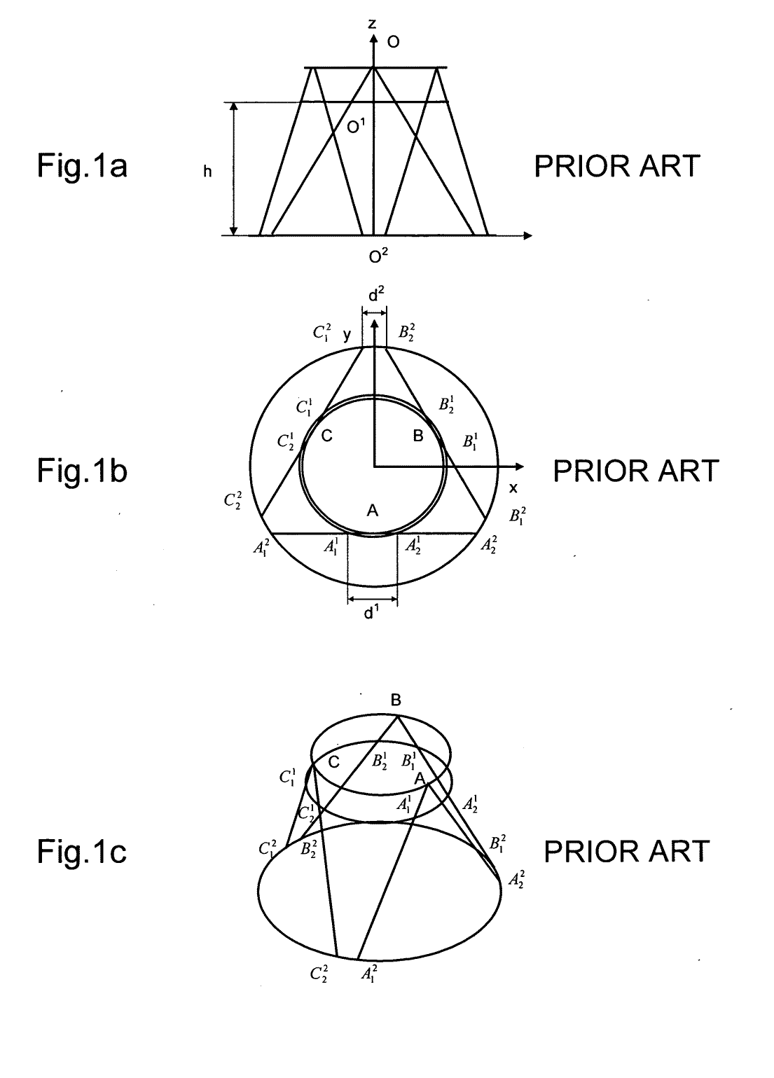

FIG. 2 is a perspective view of a known force/moment sensor;

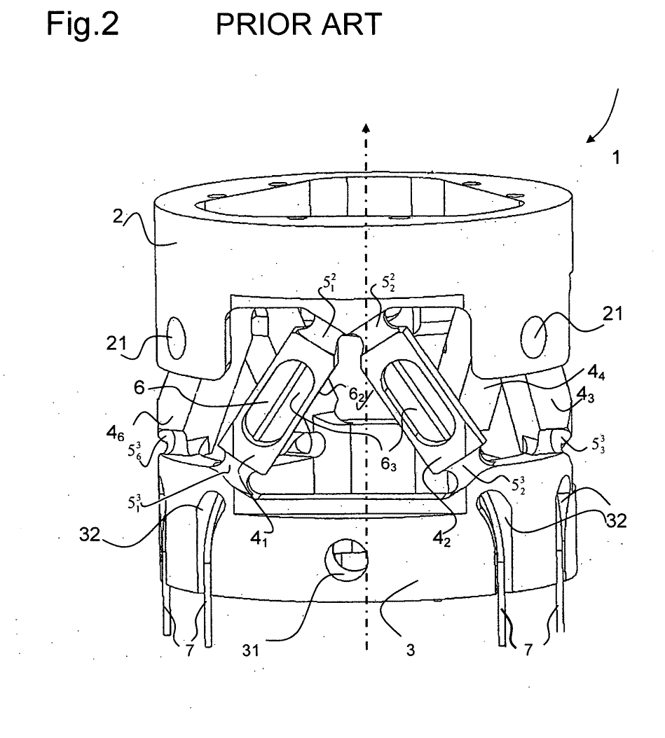

FIG. 3 is a view of a first embodiment of the force/moment sensor of the invention; and

FIG. 4 is a view of a second embodiment of the force/moment sensor of the invention.

### DETAILED DESCRIPTION OF THE PREFERRED EMBODIMENTS

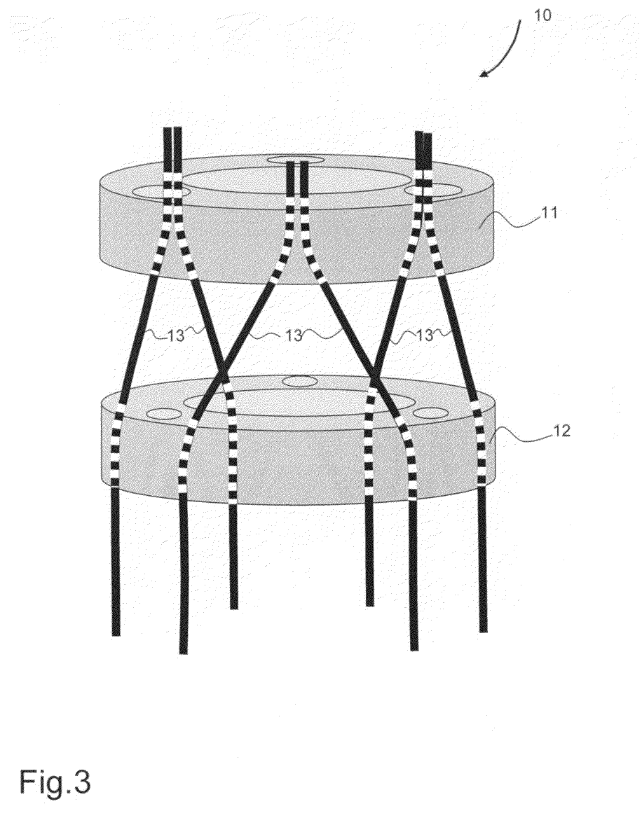

Illustrated in FIG. 3, in a perspective schematic view, is a first embodiment of the force/moment sensor 10 comprising two mutually spaced platforms 11 and 12 of a preferably annular shape. However, hexagonal platforms or platforms with larger number of edges are useful as well. The platforms 11 and 12 can be produced by injection-molding from plastic, by sintering from plastic/metal or by machining from plastic and metal or from ceramics/ glass.

As shown in FIG. 3, the two platforms 11 and 12 have arranged therebetween six rod-shaped elements in the form of glass fibers 13 which, when left in the unloaded condition between the platforms, will preferably have the same length and which are fixed in the platforms 11 and 12. On said rod-shaped elements 13 formed as glass fibers, fiber Brigg gratings are used as measurement sites; this feature is not shown in greater detail in FIG. 3.

In this arrangement, the exact orientation of the glass fibers 13 with regard to angle, tilting etc. can be varied already in the design phase and be set in a suitable manner so as to adapt the load capacity of the force/moment sensor to the expected loading situations.

To make it possible to perform a measurement of all six possible load components, i.e. three orthogonal forces and three moments, the individual measurement sites are not allowed to be arranged parallel to each other.

A smaller number of measurement sites is generally possible; thus, for instance, a force/moment sensor with three measurement sites is suited for three degrees of freedom. Generally, what is required is a number of more than two measurement sites which are not arranged on a straight line. On the other hand, also more than six sites are possible. Such a redundancy will then contribute to the improvement of the measurement result or can be used for temperature compensation.

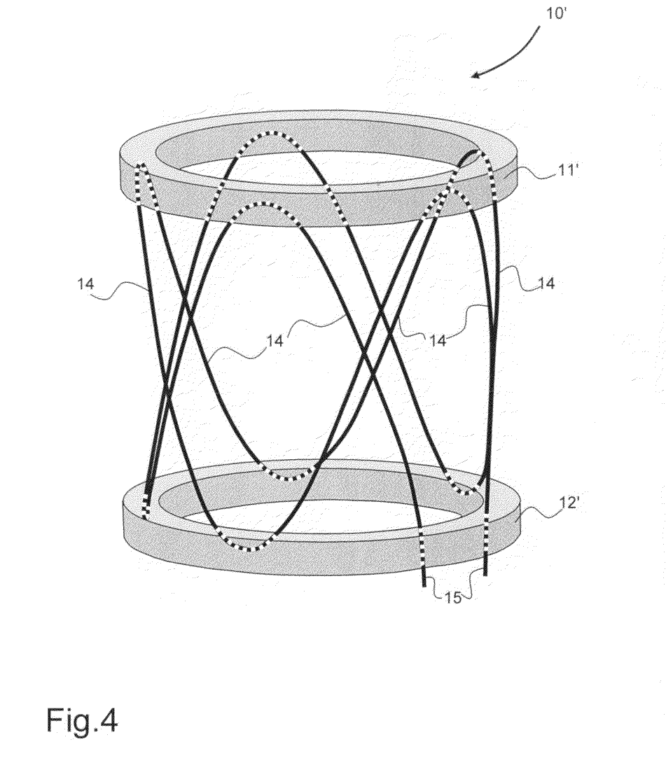

FIG. 4 illustrates, in a further perspective schematic view, a second embodiment of a force/moment sensor 10′ which again comprises two mutually spaced and e.g. annular platforms 11′ and 12′. Between the two platforms 11′ and 12′ shown in FIG. 4, rod-shaped elements 14 are provided which together form one continuous glass fiber 15 wound in an undulating configuration around a virtual cylinder. The ends of the rod-shaped elements 14 of glass fiber 15 are fixed in the annular platforms 11′ and 12′. Also in the second embodiment, the rod-shaped elements 14 of said one continuous fiber 15 are provided with fiber Brigg gratings between the platforms 11′,12′ for use as measurement sites.

Thus, in the above embodiment, it is of particular advantage that only one glass fiber is required for transmission of all measurement values. Also the coupling of the force/moment sensor to a robotic structure is simplified thereby.

The structure of the second embodiment as well as that of the first embodiment generally follows the layout of the so-called Stewart platform. Under the precondition that a suitable distance exists between the measurement sites, a fiber can also be wound a plurality of times in an overlapping manner around the virtual cylinder. Thereby, the properties of the force/moment sensor will be influenced; particularly, the stiffness is increased.

According to a modification of the second embodiment, the reversal points of the continuous glass fiber can also be arranged externally of at least one of said platforms 11′ or 12′. This offers the possibility to “thread” the continuous glass fiber through the platforms 11′ and 12′.

Force/moment sensors configured according to the invention can be utilized in an advantageous manner e.g. in gripping devices as employed in medical technology, or also in instruments employed in minimal-invasive surgery (MIC). Further, force/moment sensors configured according to the invention can be accommodated e.g. in the fingertips of a robotic hand.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A force/moment sensor for measuring at least three orthogonal loads, comprising:
two platforms, each platform having at least three support point elements formed thereon; and
at least three identical rod-shaped elements arranged between the two platforms, each of said rod-shaped elements being provided with at least one member reacting on an applied force,
wherein
said rod-shaped elements are glass fibers which have no support structure and which are fixed in said platforms so that each respective glass fiber takes up only longitudinal forces when loads are acting in a random direction on one of said two platforms, whereas the other platform is fixed in position.

2. The force/moment sensor according to claim 1, wherein the glass fibers are provided with a coating thereon.

3. The force/moment sensor according to claim 1, wherein the glass fibers are double-refraction fibers.

4. A force/moment sensor for measuring at least three orthogonal loads, comprising:
two platforms, each platform having at least three support point elements formed thereon; and
identical rod-shaped portions arranged between the two platforms, each rod-shaped portion being provided with a member reacting on an applied force,
wherein
said rod-shaped portions form one continuous glass fiber or a small number of glass fibers, said one or plurality of fibers being wound in an undulating configuration around a virtual cylinder, the ends of said rod-shaped portions being respectively fixed in said platforms, and wherein at least three measurement sites are provided on said rod-shaped portions.

5. The force/moment sensor according to claim 4, wherein, with a suitable distance existing between the measurement sites, the continuous glass fiber is wound a plurality of times and in an overlapping manner around said virtual cylinder.

6. The force/moment sensor according to claim 4, wherein said one or plurality of continuous glass fibers is/are provided with a coating thereon.

7. The force/moment sensor according to claim 4, wherein reversal points of the continuous glass fiber are arranged externally of at least one of the platforms.

8. The force/moment sensor according to claim 4, wherein the continuous glass fiber is a double-refraction fiber.

9. Use of the force/moment sensor according to claim 1 in gripping devices employed in medical technology.

10. Use of the force/moment sensor according to claim 4 in gripping devices employed in medical technology.

11. Use of the force/moment sensor according to claim 1 in instruments employed in minimal-invasive surgery (MIC).

12. Use of the force/moment sensor according to claim 4 in instruments employed in minimal-invasive surgery (MIC).

13. Use of the force/moment sensor according to claim 1 in the fingertips of a robotic hand.

14. Use of the force/moment sensor according to claim 4 in the fingertips of a robotic hand.
